(19) United States
(12) Patent Application Publication
(10) Pub. No.: US 2012/0176817 A1
(43) Pub. Date: Jul. 12, 2012

(54) DC-DC CONVERTER

(75) Inventor: Bing Lu, Manchester, NH (US)

(73) Assignee: Texas Instruments Incorporated, Dallas, TX (US)

(21) Appl. No.: 12/986,692

(22) Filed: Jan. 7, 2011

(51) Int. Cl. H02M 3/335

(52) U.S. Cl. 363/21.02

(57) ABSTRACT

A DC-DC converter has at least first and second power converters, with the inputs of the power converters connected in series so that DC current through the input of the first power converter also flows through the input of the second power converter, and the outputs of the power converters are connected in parallel.

### BACKGROUND

Power supplies and DC-DC converters are commonly operated in parallel for reliability (redundancy) and load sharing. Power supplies and DC-DC converters commonly produce an output current that is a rectified sine-wave. The resulting rectified sine-wave is then filtered to provide suitable DC power. The capacitors required for filtering may be large and expensive. It is common to operate two supplies or converters in parallel, with output currents offset in phase, so that the combined rectified outputs have overlapping ripple, which substantially reduces the size of the capacitors needed for filtering.

FIG. 1 illustrates a DC-DC converter circuit 100 comprising a first power converter 102 and a second power converter 104 operating in parallel to provide shared power to a load 106. The output current of the first converter 102 is depicted by waveform 108. The output current of the second converter 104 is depicted by waveform 110. The combined currents are depicted by waveform 112. If the second converter 104 was not present, the current ripple seen by capacitor 114 would be as depicted by waveform 108, but with the second converter 104 present, the current ripple seen by capacitor 114 is reduced, as depicted by waveform 112.

There is an ongoing need for a DC-DC converter circuit using a plurality of efficient resonant converters with load sharing and with reduced output ripple.

### BRIEF DESCRIPTION OF THE DRAWINGS

FIG. 1 is a block diagram of an example prior art embodiment of a DC-DC converter with power converters operating in parallel.

FIG. 2 is a block diagram illustrating an example embodiment of a DC-DC converter with load sharing but with the power converters not operating in parallel.

FIG. 3 is a circuit diagram illustrating additional detail for an example embodiment of a DC-DC converter configured as in FIG. 2, with the power converters being LLC resonant converters.

FIG. 4 is waveform diagram, and a block diagram, for the DC-DC converter of FIG. 3, illustrating switching states during phases of the clock signals.

FIG. 5 is a flow chart of an example embodiment of a method for making a DC-DC converter.

### DETAILED DESCRIPTION

There is an ongoing demand to improve the efficiency of power supplies and DC-DC converters. One power converter configuration, called an LLC resonant converter, is particularly efficient and is the power converter of choice in many applications. An LLC resonant converter has a resonant circuit that is effectively in series with the output load. The impedance of the resonant circuit varies with frequency, and changing the frequency changes the voltage across the output load. Accordingly, the voltage gain is frequency dependent, and in a closed-loop system, the voltage gain of a LLC resonant converter is controlled by frequency. The impedance of the resonant circuit is at a minimum at its resonant frequency. Accordingly, for maximum efficiency, the resonant circuit needs to operate at its resonant frequency to transfer the maximum amount of power to the output load.

It would be desirable to operate two LLC resonant converters in parallel, with identical frequency but phase-offset clocks, to produce overlapping output ripple as discussed in conjunction with FIG. 1. However, this does not work with LLC resonant converters. Ripple reduction requires both power converters to operate at the same frequency. Load sharing and ripple reduction, as in FIG. 1, requires both power converters to operate at the same frequency, but with independently controllable voltage gains. For example, if the voltage gain of the power converter modules 102 and 104 is controlled by pulse-width modulation, they can run at the same frequency but the voltage gains can be controlled independently. In contrast, the voltage gain of an LLC converter is controlled by frequency. Because of inherent variation in components, any two LLC resonant converters will have slightly different resonant frequencies, and slightly different voltage gains at any particular frequency. In FIG. 1, if the first and second power converters (102, 104) are LLC converters, and if the first power converter 102 is operating at its resonant frequency (for maximum efficiency), then the voltage gain of the first power converter will be greater than the voltage gain of the second power converter 104 (which will not be operating at its resonant frequency). Since the input voltages are the same, and the voltage gains are different, the output voltage generated by converter 102 will be greater than the output voltage generated by the first power converter 104. As a result, the DC voltage across capacitor 114 will be greater than the peak voltage generated by the second power converter 104, the rectification diode 116 will be backward biased, and the second power converter 104 will not provide any current to the load 106.

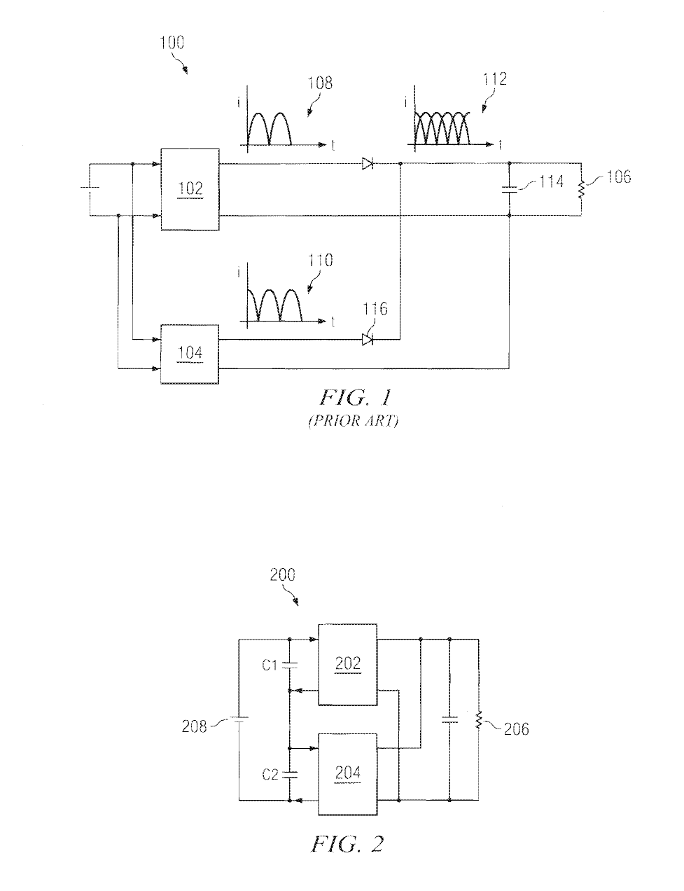

FIG. 2 illustrates an example embodiment of a DC-DC converter 200 having two power converters (202, 204), in which the outputs of the power converters are connected in parallel, for sharing of power to a load 206. As a DC-DC converter, circuit 200 converts DC power at one voltage (voltage source 208) to DC power at a different voltage (DC voltage across the load 206). The inputs of the power converters are connected in series so that DC input current through power converter 202 also passes in series through power converter 204, so the DC input currents through the power converters are the same. The outputs of the power converters are connected in parallel, so the DC output voltages of the power converters are the same. The following equations apply.

V_{IN1}×G₁=V_{O}

V_{IN2}×G₂=V_{O}

P_{IN1}=V_{IN1}×I_{IN}

P_{IN2}=V_{IN2}×I_{IN}

P_{IN1}/P_{IN2}=G₂/G₁

### Where:

I_{IN} is the DC input current for power converters 202 and 204.
V_{O} is the DC output voltage for power converters 202 and 204.
V_{IN1} is the DC input voltage for power converter 202.
V_{IN2} is the DC input voltage for power converter 204.
G₁ is the DC voltage gain for power converter 202.
G₂ is the DC voltage gain for power converter 204.
P_{IN1} is the DC input power for power converter 202.
P_{IN2} is the DC input power for power converter 204.

From the above, it can be seen that input power sharing is determined by the ratio of the gains, which typically will be close to each other (the ratio will typically be approximately equal to one). Each power converter will supply approximately half of the output power, and in particular, each power converter will provide approximately half the current to the load 206. As a result of slightly unequal input power, the input voltages V_{IN1} and V_{IN2} will adjust to be slightly different, with the power converter having the smaller gain having a higher input voltage.

In the example of FIG. 2, there are two power converters. With two power converters, the phase of the clocks may be offset by one-fourth of the dock period as depicted in FIG. 1. There may be more than two power converters. For example, with three power converters, there may be three clocks. If a first clock series as a reference for phase, the phase of a second clock may be offset by one-sixth of the period, and the phase of a third clock may be offset by one-third of the period.

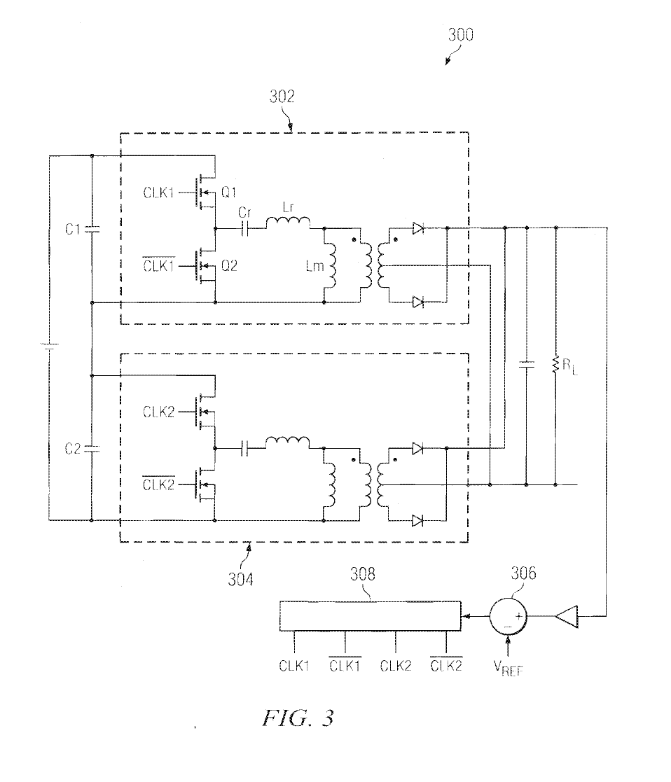

FIG. 3 illustrates a DC-DC converter 300 having two power converters (302, 304), configured as in FIG. 2, for sharing of power to a load 306. In the example of FIG. 3, power converters 302 and 304 are LLC resonant converters. Using power converter 302 as an example, a pair of switches (Q1, Q2) drives a resonant circuit (Lᵣ, Lₘ, Cᵣ). The gate of each switch is controlled by a clock signal (CLK1, C̅L̅K̅1̅). Note, for simplicity in explanation and illustration, FIG. 2 does not show a dead time that is typically added between the switching times to prevent shoot through. A load (RD is transformer coupled to the resonant circuit. The resonant circuit acts as a voltage divider. The impedance of the resonant circuit varies with frequency. A summing junction 306 subtracts a reference voltage from the output voltage, generating an error signal (which may be a voltage or a current). The error signal drives an oscillator 308 (which may be a voltage-controlled oscillator or a current-controlled oscillator, depending on the error signal), which generates four clock signals (CLK1, C̅L̅K̅1̅, CLK2, C̅L̅K̅2̅) CLK1 and CLK2 have the same frequency, but CLK2 is offset in phase by one-fourth cycle ninety degrees) relative to CLK1. As the load changes, the oscillator 308 changes the switching frequency to increase or decrease the impedance of the circuits, thereby increasing or decreasing the voltage across the load.

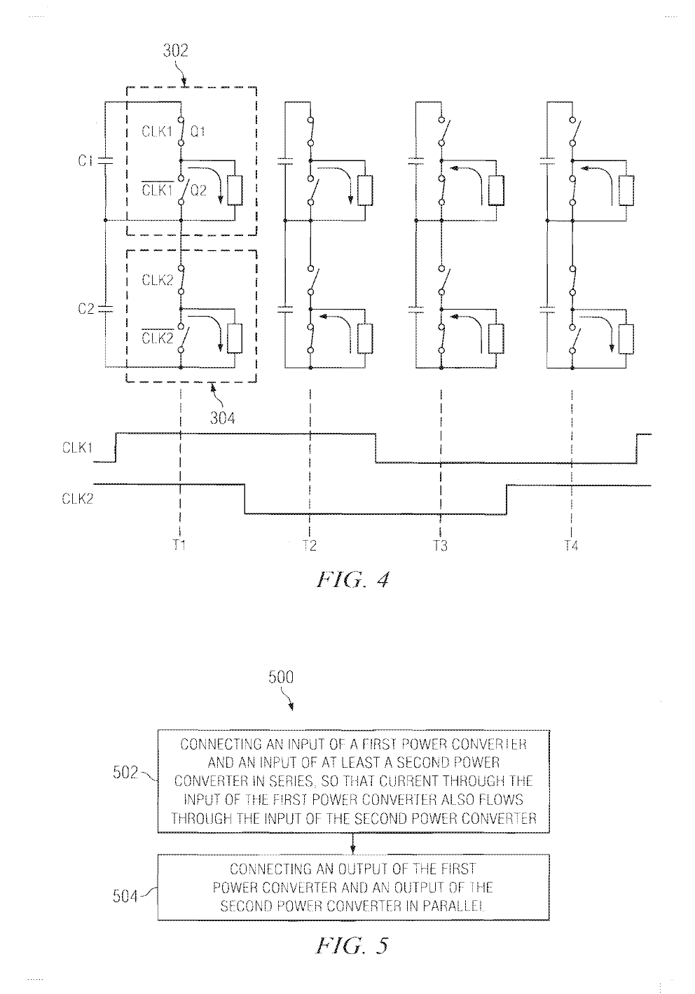

FIG. 4 illustrates the clocks signals CLK1 and CLK2 in FIG. 2, and illustrates switching states of the power converters 302 and 304 at each state of the clock signals CLK1 and CLK2 (times T1, T2, T3, T4). In the example depicted in FIG. 4, CLK2 leads CLK1 by one-fourth of a clock period. In FIG. 4, transistors Q1 and Q2 in FIG. 3 are depicted as switches. The remainder of each power converter is depicted as a box. In FIG. 4, it is assumed for purposes of illustration only that a high clock signal closes a switch being controlled by the clock signal. For example, at time T1, CLK1 is high, so Q1 is closed, and C̅L̅K̅1̅ is low, so Q2 is open. The lines with arrows depict the direction of the resulting AC current flow in the resonant circuits. For example, at time T1, AC current flows through Q1 and then in a clockwise direction through the resonant circuit of power converter 302. Note that alternating currents in the resonant circuits will generate alternating currents in the input capacitors C1 and C2, but DC currents for the two power converters will be the same, and DC voltages across C1 and C2 will be slightly different.

FIG. 5 illustrates a method 500 for making a DC-DC converter. Note that no order is implied by the arrangement of steps in the figure, and some steps may occur simultaneously. At step 502, inputs of a first power converter and at least a second power converter are connected in series so that the same DC current flows through the input of each power converter. At step 504, the outputs of the first and second power converters are connected in parallel.

What is claimed is:

1. A DC-DC converter, comprising:
a first power converter having an input and an output;
at least one additional power converter having an input and an output;
the input of the first power converter and the input of the additional power converter connected in series so that DC current flowing through the input of the first power converter also flows through the input of the additional power converter; and
the outputs of the power converters connected in parallel.

2. The DC-DC converter of claim 1, where the first and second power converters are LLC resonant converters.

3. The DC-DC converter of claim 1, further comprising:
the first power converter receiving a first clock signal;
the additional power converter receiving a second clock signal;
the first and second clock signals having the same frequency; and,
the phase of the second clock signal being offset relative to the phase of the first clock signal.

4. The DC-DC converter of claim 3, where the second clock signal is offset in phase by one-fourth clock period relative to the first clock signal.

5. The DC-DC converter of claim 3, where the first and second clock signals are generated by an oscillator.

6. The DC-DC converter of claim 5, where the oscillator is controlled by an error signal, the error signal depending on a difference between a reference voltage and an output voltage of the DC-DC converter.

7. The DC-DC converter of claim 6, where the error signal is a voltage.

8. The DC-DC converter of claim 6, where the error signal is a current.

9. The DC-DC converter of claim 1, further comprising:
the first power converter having a first voltage gain and receiving a first input power;
the additional power converter having a second voltage gain and receiving a second input power; and,
the ratio of the first input power to the second input power being proportional to the ratio of the second voltage gain to the first voltage gain.

10. The DC-DC converter of claim 1, further comprising:
the first power converter having a first DC input voltage;
the additional power converter having a second DC input voltage; and
the first DC input voltage being different than the second DC input voltage.

11. A method, comprising:
connecting an input of a first power converter and an input of at least a second power converter in series so that current through the input of the first power converter also flows through the input of the second power converter; and
connecting an output of the first power converter and an output of the second power converter in parallel.

12. The method of claim 11, further comprising:
connecting the first power converter to a first clock signal; and
connecting the second power converter to a second clock signal, where the first and second clock signals have the same frequency and the first and second clock signals do not have the same phase.

13. The method of claim 12, where the first and second clock signals are offset in phase by one-fourth of a period.

14. The method of claim 12, further comprising:
generating an error signal comprising a difference between a reference voltage and a voltage output of the first and second power converters;
controlling a voltage controlled oscillator with the error signal to generate the first and second clock signals.
